(19) United States
(12) Patent Application Publication
(10) Pub. No.: US 2021/0235840 A1
(43) Pub. Date: Aug. 5, 2021

(54) Razor Head Cleaning Device

(71) Applicant: Moises Kattan, Tampa, FL (US)

(72) Inventor: Moises Kattan, Tampa, FL (US)

(21) Appl. No.: 16/781,365

(22) Filed: Feb. 4, 2020

(51) Int. Cl. A45D 27/46; B08B 3/02

(52) U.S. Cl. CPC A45D 27/46; B08B 3/02; B08B 2203/027; B08B 2203/0211

(57) ABSTRACT

A razor head cleaning device for improved comfort, performance, and hygiene includes a housing that defines an interior space. A plurality of walls, which is coupled to the housing and positioned in the interior space, defines a reservoir and a chamber. The housing has a front, which has a slot positioned therein that opens into the chamber. A plurality of nozzles is coupled to a top of the housing and positioned in the chamber. A stream of fluid that is expelled from the nozzles contacts a razor head of a shaving razor that is inserted through the slot into the chamber. A pump, which is coupled to the housing and positioned in the interior space, pumps the fluid from the reservoir through the nozzles to clean the razor head.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cleaning devices and more particularly pertains to a new cleaning device for improved comfort, performance, and hygiene.

### (2) Description of Related Art Including Information Disclosed Under 37 CFR 1.97 and 1.98

The prior art relates to cleaning devices for razor head, such as single blade and multiblade razor heads. Prior art razor cleaning devices generally comprise an apparatus that utilizes tap water directed through a nozzle to remove debris from a razor.

### BRIEF SUMMARY OF THE INVENTION

An embodiment of the disclosure meets the needs presented above by generally comprising a housing that defines an interior space. A plurality of walls, which is coupled to the housing and positioned in the interior space, defines a reservoir and a chamber. The housing has a front, which has a slot positioned therein that opens into the chamber. A plurality of nozzles is coupled to a top of the housing and positioned in the chamber. A stream of fluid that is expelled from the nozzles contacts a razor head of a shaving razor that is inserted through the slot into the chamber. A pump, which is coupled to the housing and positioned in the interior space, is configured to pump a fluid from the reservoir through the nozzles to clean the razor head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a razor head cleaning device according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is an isometric perspective view of an embodiment of the disclosure.

FIG. 6 is a cross-sectional view of an embodiment of the disclosure.

### DETAILED DESCRIPTION OF THE INVENTION

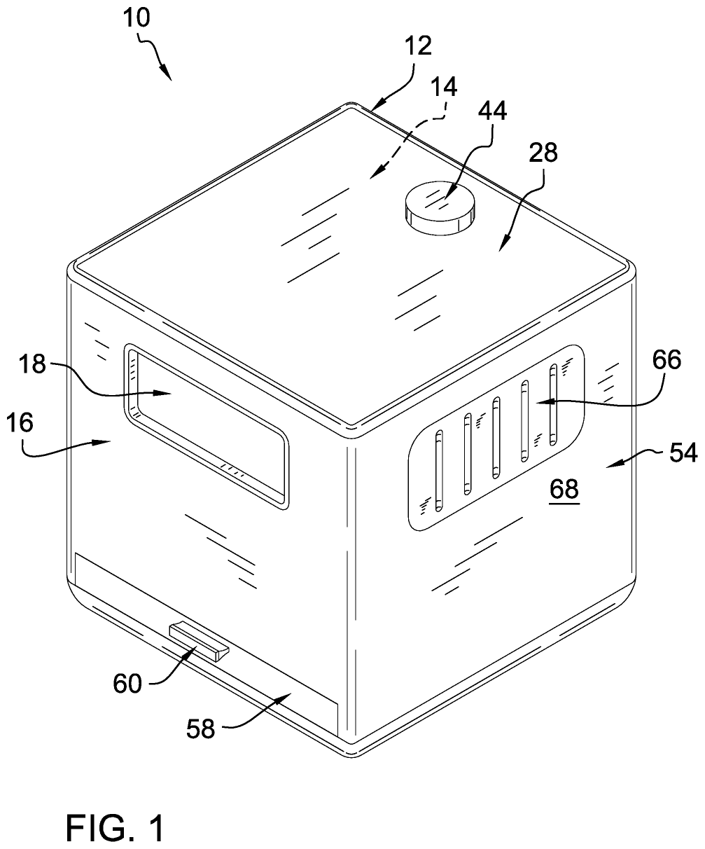

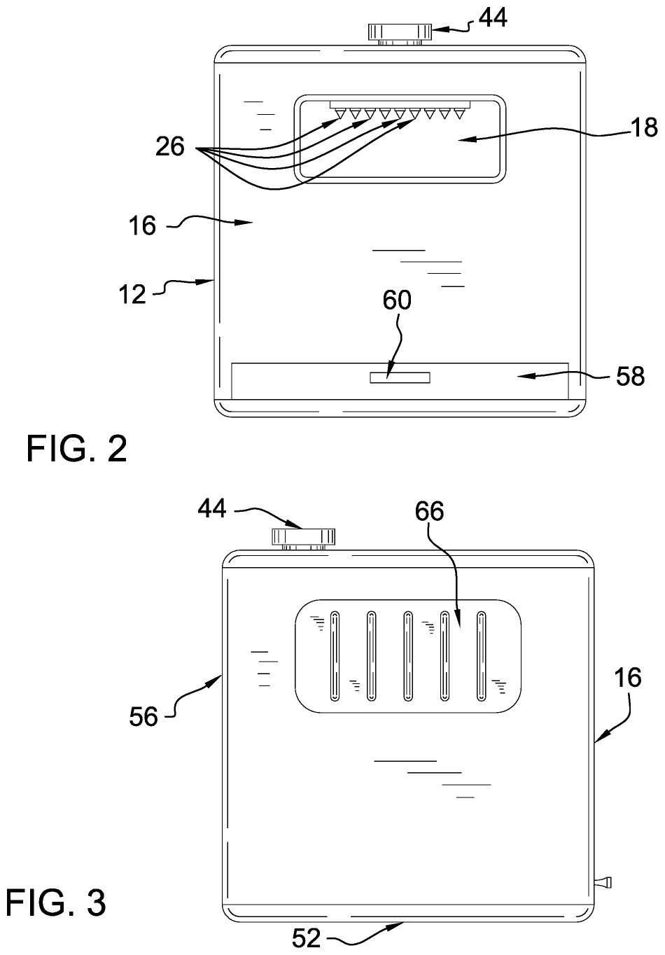

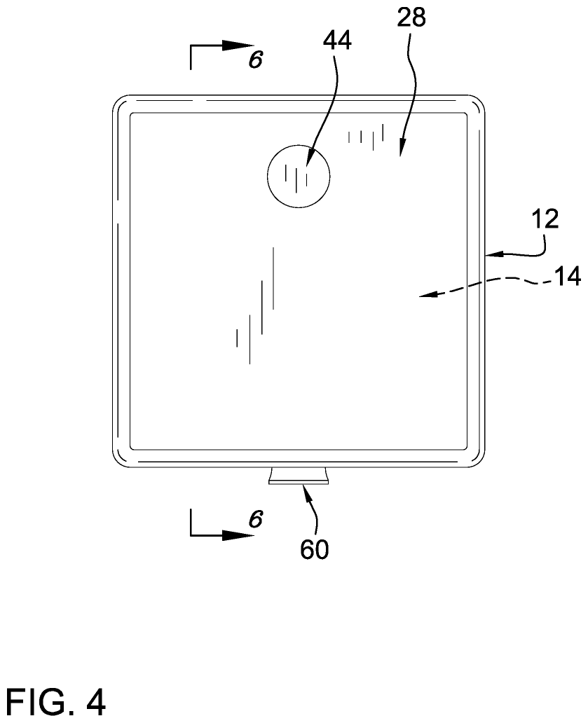

With reference now to the drawings, and in particular to FIGS. 1 through 6 thereof, a new cleaning device embodying the principles and concepts of an embodiment of the disclosure and generally designated by the reference numeral 10 will be described.

As best illustrated in FIGS. 1 through 6, the razor head cleaning device 10 generally comprises a housing 12, which defines an interior space 14. The housing 12 has a front 16, which has a slot 18 positioned therein. A plurality of walls 20, which is coupled to the housing 12 and is positioned in the interior space 14, defines a reservoir 22 and a chamber 24. The slot 18 opens into the chamber 24.

A plurality of nozzles 26 is coupled to a top 28 of the housing 12 and positioned in the chamber 24. A stream of fluid that is expelled from the nozzles 26 contacts a razor head of a shaving razor that is inserted through the slot 18 into the chamber 24. The nozzles 26 of the plurality of nozzles 26 is linearly arrayed in parallel to the front 16 of the housing 12. The nozzles 26 are configured to direct the stream of fluid along a width of the razor head.

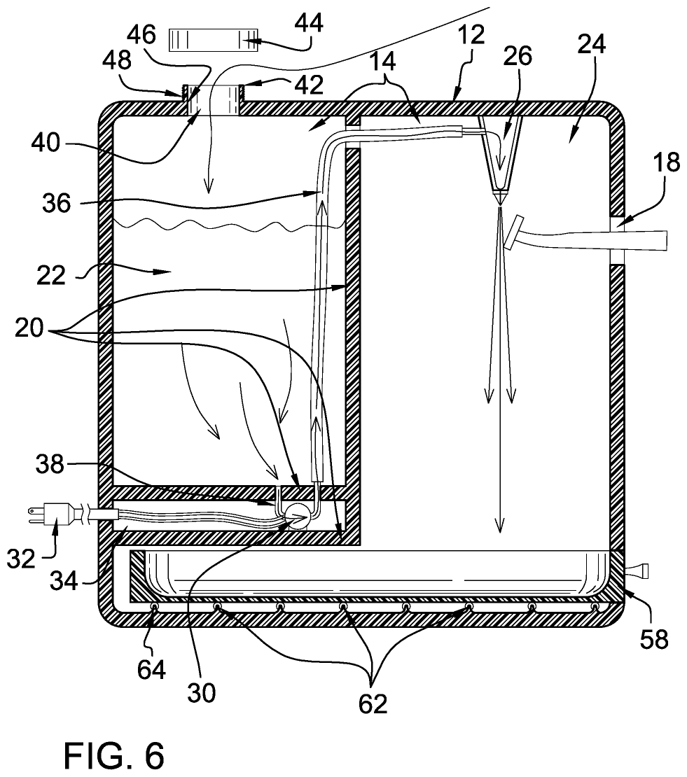

A pump 30, which is coupled to the housing 12 and positioned in the interior space 14, is configured to pump a fluid, such as water, disinfectant solution, and the like, from the reservoir 22 through the nozzles 26 to clean the razor head of debris, such as hairs. Typically, a user would clean the razor head by flushing it with water and forcefully tapping the razor head against a solid object, like the edge of a sink. The pump 30 may be powered by means of an electrical cord 32, as shown in FIG. 6. The present invention also anticipated the pump 30 being battery powered.

The plurality of walls 20 also defines a compartment 34 in which the pump 30 is positioned, as shown in FIG. 6. A tube 36 is coupled to and extends between the pump 30 and the plurality of nozzles 26 so that the pump 30 is in fluidic communication with the plurality of nozzles 26. A pipe 38 is coupled to and extends between the reservoir 22 and the pump 30 so that the pump 30 is in fluidic communication with the reservoir 22.

The top 28 of the housing 12 has an orifice 40 positioned therein that opens into the reservoir 22. The orifice 40 is configured for addition of the fluid to the reservoir 22. A lip 42 is coupled to the top 28 of the housing 12 and extends from the orifice 40. A cap 44 is selectively couplable to the lip 42 to close the orifice 40. The lip 42 may be externally threaded and the cap 44 internally threaded so that the cap 44 can threadedly engage the lip 42, as shown in FIG. 6. The present invention anticipates other means of engaging the cap 44 to the lip 42, such as, but not limited to, frictional coupling of the cap 44 to an inner perimeter 46 of the lip 42, frictional coupling of the cap 44 to an outer perimeter 48 of the lip 42, and the like.

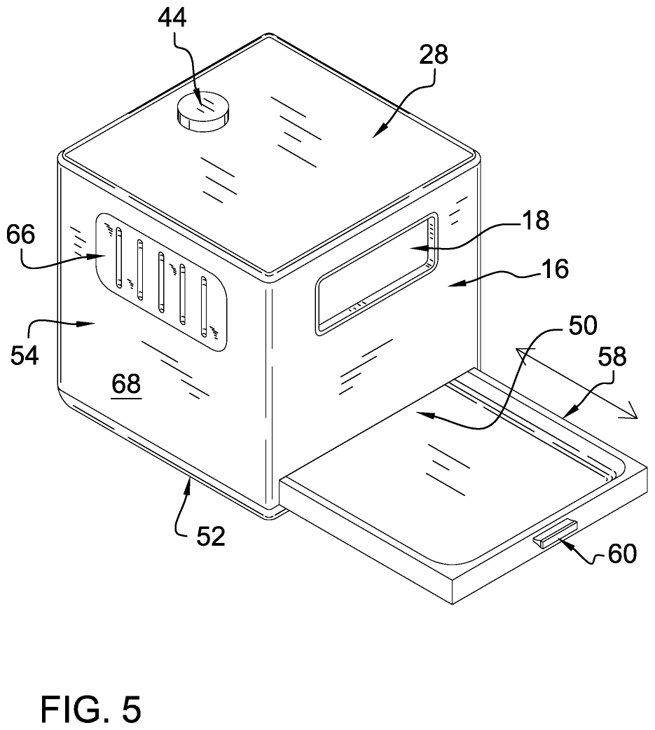

The front 16 of the housing 12 has an aperture 50 positioned therein proximate to a bottom 52 of the housing 12. The aperture 50 extends between opposed sides 54 of the housing 12. The present invention also anticipates the aperture 50 being positioned in one of a back 56 and a respective opposed side 54 of the housing 12. A tray 58 is selectively insertable into the aperture 50, as shown in FIG. 5. A handle 60 is coupled to the tray 58 and is configured to be gripped by digits of a hand of the user to position the tray 58 within the aperture 50. The tray 58 is configured to collect the fluid that is expelled from the nozzles 26 and debris that is dislodged from the razor head.

A plurality of rollers 62 is engaged to the bottom 52 of the housing 12 and positioned in the chamber 24. Each roller 62 has an axis of rotation 64 that is parallel to the front 16 of the housing 12. The rollers 62 are configured to facilitate sliding of the tray 58 along the bottom 52 of the housing 12.

A plurality of grips 66 is engaged to an exterior surface 68 of the housing 12. The grips 66 are configured to enhance a grasp of the hand of the user upon the housing 12. The plurality of grips 66 may comprise two grips 66 that are positioned singly on the opposed sides 54 of the housing 12 proximate to the top 28 of the housing 12. The grips 66 may comprise rubber, or other gripping material, such as, but not limited to, silicone, elastomer, and the like.

In use, the user grasps the shaving razor and inserts the razor head through the slot 18 into the chamber 24 so that the razor head is positioned beneath the nozzles 26. The stream of fluid that is expelled from the nozzles 26 contacts the razor head to dislodge debris to clean the razor head. The debris and the fluid are collected in the tray 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A razor head cleaning device comprising:
a housing defining an interior space, the housing having a front, the front having a slot positioned therein;
a plurality of walls coupled to the housing and positioned in the interior space defining a reservoir and a chamber, the slot opening into the chamber;
a plurality of nozzles coupled to a top of the housing and positioned in the chamber such that a stream of fluid expelled from the nozzles contacts a razor head of a shaving razor inserted through the slot into the chamber; and
a pump coupled to the housing and positioned in the interior space and configured for pumping a fluid from the reservoir through the nozzles for cleaning the razor head.

2. The razor head cleaning device of claim 1, wherein the nozzles of the plurality of nozzles in linearly arrayed in parallel to the front of the housing wherein the nozzles are configured for directing the stream of fluid along a width of the razor head.

3. The razor head cleaning device of claim 1, further including:
the plurality of walls defining a compartment, the pump being positioned in the compartment;
a tube coupled to and extending between the pump and the plurality of nozzles such that the pump is in fluidic communication with the plurality of nozzles; and
a pipe coupled to and extending between the reservoir and the pump such that the pump is in fluidic communication with the reservoir.

4. The razor head cleaning device of claim 1, further including the top of the housing having an orifice positioned therein, the orifice opening into the reservoir wherein the orifice is configured for addition of the fluid to the reservoir.

5. The razor head cleaning device of claim 4, further including:
a lip coupled to the top of the housing and extending from the orifice; and
a cap selectively couplable to the lip for closing the orifice.

6. The razor head cleaning device of claim 1, further including:
the front of the housing having an aperture positioned therein proximate to a bottom of the housing, the aperture extending between opposed sides of the housing; and
a tray selectively insertable into the aperture wherein the tray is configured for collecting the fluid expelled from the nozzles and debris dislodged from the razor head.

7. The razor head cleaning device of claim 6, further including a handle coupled to the tray wherein the handle is configured for gripping by digits of a hand of a user for positioning the tray within the aperture.

8. The razor head cleaning device of claim 6, further including a plurality of rollers engaged to the bottom of the housing and positioned in the chamber such that each roller has an axis of rotation parallel to the front of the housing wherein the rollers are configured for facilitating sliding of the tray along the bottom of the housing.

9. The razor head cleaning device of claim 1, further including a plurality of grips engaged to an exterior surface of the housing wherein the grips are configured for enhancing a grasp of the hand of the user upon the housing.

10. The razor head cleaning device of claim 9, wherein the plurality of grips comprises two grips positioned singly on opposed sides of the housing proximate to the top of the housing.

11. The razor head cleaning device of claim 9, wherein the grips comprise rubber.

12. A razor head cleaning device comprising:
a housing defining an interior space, the housing having a front, the front having a slot positioned therein;
a plurality of walls coupled to the housing and positioned in the interior space defining a reservoir and a chamber, the slot opening into the chamber;
a plurality of nozzles coupled to a top of the housing and positioned in the chamber such that a stream of fluid expelled from the nozzles contacts a razor head of a shaving razor inserted through the slot into the chamber, the nozzles of the plurality of nozzles being linearly arrayed in parallel to the front of the housing wherein the nozzles are configured for directing the stream of fluid along a width of the razor head;
a pump coupled to the housing and positioned in the interior space and configured for pumping a fluid from the reservoir through the nozzles for cleaning the razor head, the plurality of walls defining a compartment, the pump being positioned in the compartment;
a tube coupled to and extending between the pump and the plurality of nozzles such that the pump is in fluidic communication with the plurality of nozzles;
a pipe coupled to and extending between the reservoir and the pump such that the pump is in fluidic communication with the reservoir;
the top of the housing having an orifice positioned therein, the orifice opening into the reservoir wherein the orifice is configured for addition of the fluid to the reservoir;
a lip coupled to the top of the housing and extending from the orifice;
a cap selectively couplable to the lip for closing the orifice;
the front of the housing having an aperture positioned therein proximate to a bottom of the housing, the aperture extending between opposed sides of the housing;
a tray selectively insertable into the aperture wherein the tray is configured for collecting the fluid expelled from the nozzles and debris dislodged from the razor head;
a handle coupled to the tray wherein the handle is configured for gripping by digits of a hand of a user for positioning the tray within the aperture;
a plurality of rollers engaged to the bottom of the housing and positioned in the chamber such that each roller has an axis of rotation parallel to the front of the housing wherein the rollers are configured for facilitating sliding of the tray along the bottom of the housing; and
a plurality of grips engaged to an exterior surface of the housing wherein the grips are configured for enhancing a grasp of the hand of the user upon the housing, the plurality of grips comprising two grips positioned singly on the opposed sides of the housing proximate to the top of the housing, the grips comprising rubber.
